(19) United States
(12) Patent Application Publication
(10) Pub. No.: US 2026/0118245 A1
(43) Pub. Date: Apr. 30, 2026

(54) AN ANALYSIS APPARATUS AND METHOD

(71) Applicant: ENTIA LIMITED, London (GB)

(72) Inventors: Liam Graham Pegram, London (GB); Thuy-Vi Aurélie Truong, London (GB)

(21) Appl. No.: 18/857,978

(22) PCT Filed: Apr. 14, 2023
(86) PCT No.: PCT/GB2023/015009

§ 371 Date: Oct. 18, 2024

(30) Foreign Application Priority Data
Apr. 19, 2022 (GB) 2205679.0

(51) Int. Cl. G01N 15/04; B04B 13/00; B04B 15/00; G01N 15/05

(52) U.S. Cl. CPC G01N 15/042; B04B 15/00; G01N 15/05; B04B 2013/006; G01N 2015/045

(57) ABSTRACT

An apparatus for analysing a sample, the apparatus comprising: a centrifuge rotor having an analysis site suitable for receiving a sample holder having an elongate sample chamber, the analysis site extending between an inner end, which is at a first distance from a centre of rotation of the rotor, and an outer end, which is at a second distance from the centre of rotation of the rotor, the inner end being closer to a centre of rotation of the rotor than the outer end; a carriage having an illumination arrangement and an image sensor; and a drive arrangement operable to drive the carriage along a trajectory with respect to the rotor, the trajectory extending between a first location which is relatively close to the centre of rotation of the rotor, and a second location which is relatively far from the centre of rotation of the rotor, the trajectory extending over at least part of the radial distance between the inner and outer ends of the analysis site; wherein the carriage is operable, at a plurality of locations along the trajectory, to illuminate a part of the analysis site with the illumination arrangement, and to capture an image of at least a portion of the illuminated part of the analysis site with the image sensor.

### BACKGROUND

This invention relates to an apparatus and method for analysis, and in particular for analysing fluids such as blood which include two or more phases which may be separated from each other through a centrifuging process.

In existing methods for analysis of blood, a blood sample is drawn into a cuvette which includes a sample chamber. The cuvette is loaded into a centrifuge and rotated rapidly, causing the various phases of the blood to separate. Following this process, the blood in the sample chamber is illuminated, and images of the blood are captured for analysis.

### SUMMARY

It is an object of the invention to provide an improved method and apparatus for carrying out analysis of this type.

Accordingly, one aspect of the present invention provides an apparatus for analysing a sample, the apparatus comprising: a centrifuge rotor having an analysis site suitable for receiving a sample holder having an elongate sample chamber, the analysis site extending between an inner end, which is at a first distance from a centre of rotation of the rotor, and an outer end, which is at a second distance from the centre of rotation of the rotor, the inner end being closer to a centre of rotation of the rotor than the outer end; a carriage having an illumination arrangement and an image sensor; and a drive arrangement operable to drive the carriage along a trajectory with respect to the rotor, the trajectory extending between a first location which is relatively close to the centre of rotation of the rotor, and a second location which is relatively far from the centre of rotation of the rotor, the trajectory extending over at least part of the radial distance between the inner and outer ends of the analysis site; wherein the carriage is operable, at a plurality of locations along the trajectory, to illuminate a part of the analysis site with the illumination arrangement, and to capture an image of at least a portion of the illuminated part of the analysis site with the image sensor.

Advantageously, the illumination arrangement comprises one or more first light sources.

Preferably, the first light sources are positioned closer to the rotor than the image sensor is to the rotor.

Conveniently, the illumination arrangement comprises two or more first light sources, each of the first light sources being inclined towards a main axis of the illumination arrangement.

Advantageously, light emitted by at least two of the first light sources converges at a location which lies on or substantially on the analysis site.

Preferably, the drive arrangement is operable to cause the carriage to stop its motion at each location as an image is taken.

Alternatively, the drive arrangement is operable to drive the carriage such that motion of the carriage does not completely stop as each image is taken.

Conveniently, the illumination arrangement emits illumination only below or substantially only below a first wavelength threshold.

Advantageously, the illumination arrangement further comprising a first filter which is arranged such that light emitted from at least one of the first light sources passes through the first filter before illuminating the analysis site.

Preferably, the first filter only allows or substantially only allows light having a wavelength below the first wavelength threshold to pass therethrough.

Conveniently, the arrangement further comprises a second filter, arranged so that light impinging on the image sensor passes through the second filter.

Advantageously, the second filter only allows or substantially only allows light having a wavelength above a second wavelength threshold to pass therethrough.

Preferably, the second threshold is higher than the first threshold.

Conveniently, the illumination arrangement further comprises one or more second light sources.

Advantageously, the second light sources emit illumination at a different frequency or range of frequencies to that of the one or more first light sources.

Preferably, the light emitted by the one or more second light sources has a wavelength which is above the second threshold.

Conveniently, two first light sources are arranged so as to be parallel or generally parallel with a radius of the rotor, and wherein two of the second light sources are arranged to be perpendicular or substantially perpendicular to the radius of the rotor.

Advantageously, the arrangement further comprises a cuvette which is adapted to be received and retained at the analysis site, wherein the cuvette has an elongate analysis chamber which, when the cuvette is received and retained at the analysis site, lies parallel or substantially parallel with a radius of the rotor.

Preferably, when the cuvette is received and retained at the analysis site, in at least one rotational orientation of the rotor the trajectory of the carriage extends over the majority of the length of the sample chamber.

Conveniently, the trajectory of the carriage extends over all or substantially all of the length of the sample chamber.

Another aspect of the invention provides a method of analysing a liquid sample, the method comprising the steps of: collecting the sample in an elongate sample chamber of a cuvette; providing an apparatus according to any preceding claim; placing the cuvette in the analysis site of the rotor; rotating the rotor to centrifuge the sample; following centrifuging of the sample, driving the carriage along the trajectory, and at a one or more locations along the trajectory, illuminating a region of the sample chamber with the illumination arrangement, and capturing an image of at least part of the illuminated region of the sample chamber with the image sensor.

Advantageously, the method includes capturing images at a plurality of locations along the trajectory.

Preferably, the method includes capturing images of at least 10 regions of the sample chamber, and more preferably capturing images of at least 30 regions of the sample chamber, and yet more preferably capturing images of at least 50 regions of the sample chamber

Conveniently, the method further comprises the step of creating a composite image of all or part of the sample chamber, the composite image comprising a combination of at least part of each of the captured images.

### BRIEF DESCRIPTION OF THE DRAWINGS

In order that the invention may be more readily understood embodiments thereof will now be described, by way of example, with reference to the accompanying drawings, in which:

FIG. 1 shows a cuvette suitable for use with the invention;

FIG. 2 shows a centrifuge rotor suitable for use with the invention;

FIG. 3 is a cut-away view of an apparatus according to the invention;

FIG. 4 shows a cross-sectional view of a carriage suitable for use with the invention;

FIG. 5 shows a further view of the carriage of FIG. 4;

FIG. 6 shows a cut-away version of the view shown in FIG. 5; and

FIG. 7 is a graph of excitation and emission spectra.

### DETAILED DESCRIPTION

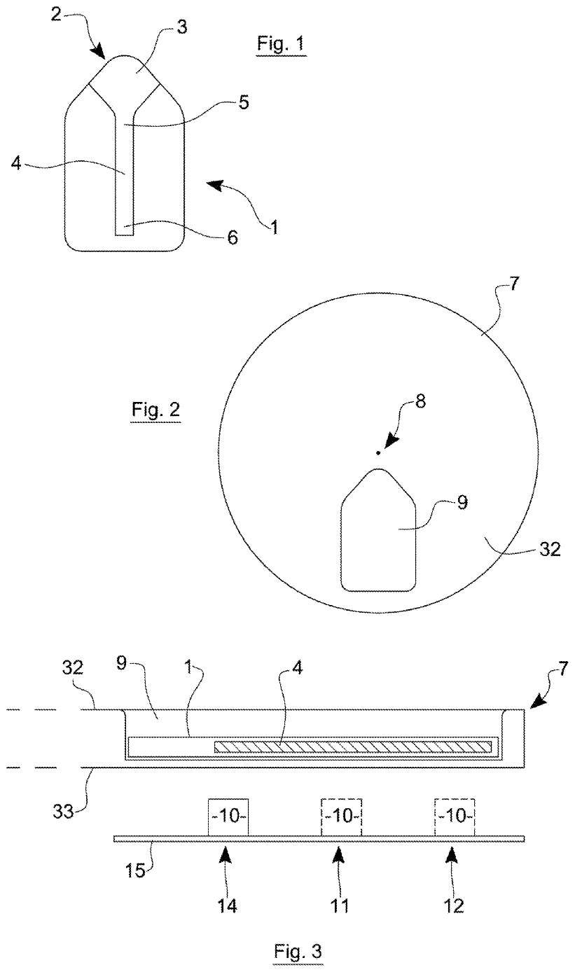

With reference to FIG. 1, a cuvette 1 is shown. The cuvette 1 has a tip 2 which may be touched against a quantity of liquid to draw a sample of the liquid into a first chamber 3. The liquid is preferably drawn into the first chamber 3 through capillary action, although this is not essential. The cuvette 1 also includes a sample chamber 4, which is in communication with the first chamber 3.

The sample chamber 4 is elongate and is preferably of consistent or substantially consistent width and thickness along its length.

At one end 5 the sample chamber 4 communicates with the first chamber 3. This communication may be direct, or through one or more intermediate or transition chambers (not shown in the figures). The second end 6 of the sample chamber 4 is closed, and terminates in a dead end.

The features of the cuvette 1 described above are known.

Once a sample of a liquid such as blood has been taken using the cuvette, the cuvette may be loaded into a centrifuge. In FIG. 2 a rotor 7 of a centrifuge 1 is shown. The rotor 7 is generally disc shaped, and is arranged to rotate around an axis of rotation 8.

The rotor 7 includes a recess 9 on its top side 32, which is adapted to receive the cuvette 1 in a close fit, and to hold the cuvette 1 in place during a centrifuging process.

When the cuvette 1 is inserted into the recess 9 of the rotor 7, the sample chamber 4 of the cuvette 1 will preferably be aligned or substantially aligned with a radius of the rotor 7.

During the centrifuging process the rotor 7 may, as an example, be rotated at a rate of 3,500 rpm, for a period of 20 seconds. The rotor 7 may be driven to have a ramp-up period and a ramp-down period, which may for instance each be of 30 seconds.

During the centrifuging process the liquid sample will be driven into the sample chamber 4.

Follow centrifuging of the liquid sample, the various phases of the sample will have separated, with the most dense phases lying at the second end 6 of the sample chamber 4 which is furthest from the axis of rotation 8, and the least dense phases lying closest to the axis of rotation 8.

In the case of a sample of whole blood, the red blood cells will accumulate near the second end 6 of the sample chamber 4, which is furthest from the axis of rotation 8, with the less dense serum settling closest to the axis of rotation 8. A relatively thin layer, known as the buffy coat, will lie between these two main phases.

The centrifugation of a blood sample is known, and will not be described in detail in this document.

FIG. 3 shows a schematic cross-sectional view of a region of the rotor 7 following the centrifuging process. As can be seen in FIG. 3 the cuvette 1 is received in the recess 9 of the rotor 7.

The sample chamber 4 of the cuvette 1 has a length, which is generally parallel with a radius of the rotor 7, as described above. The recess 9 of the rotor 7 preferably includes an aperture (not shown) or transparent window, which passes all the way through to a bottom side 33 of the rotor 7, and is aligned at least with the sample chamber 4 of the cuvette 1. This means that the sample chamber 4 can be viewed directly from the bottom side 33 of the rotor 7, through the aperture.

An analysis arrangement is positioned on one side of the rotor 7. In the example shown the analysis arrangement is positioned below the rotor 7, in the orientation in which the rotor 7 will be during normal use. However, it should be understood that in other examples the analysis arrangement may be positioned above the rotor 7.

The analysis arrangement includes a carriage 10, which in the examples shown in FIG. 3 is positioned below the rotor 7. In FIG. 3, the carriage 10 is shown in a first position 14, which is generally aligned with the inner end 5 of the sample chamber 4 (i.e. the end which lies closest to the axis of rotation 8).

In preferred embodiment the carriage 10 comprises one or more illumination sources and one or more imaging devices, as will be described in more detail below. The carriage 10 is adapted to illuminate at least a region of the sample chamber 4, and to capture images of the illuminated region.

The carriage 10 is movable with respect to the rotor 7, and in preferred embodiments may be driven from a first position, for instance as shown in FIG. 3, to a second position with respect to the rotor 7.

In preferred embodiment the carriage 10 may be driven along an axis which is aligned or substantially aligned with a radius of the rotor 7, although the skilled reader will appreciate that this is not essential.

The carriage 10 may be driven through a range of positions such that, when the cuvette 1 is installed in the rotor 7, the range of positions extends from one end of the sample chamber 4 to the other end of the sample chamber 4.

As described above in FIG. 3 the carriage 10 is shown in a first position 14 which is aligned or substantially aligned with the inner end of 5 of the sample chamber 4. FIG. 3 also shows, in phantom, second and third positions 11, 12 into which the carriage 10 may be driven.

FIG. 3 shows a track 15 along which the carriage 10 travels. In preferred embodiments the carriage 10 engages this track 15, and may be driven along the length of the track 15, for instance by one or more motors (not shown). Any other suitable method for moving the carriage 10 along its trajectory may be used, however.

In preferred embodiments, at the end of the centrifuging process, the carriage 10 is in the initial position 14. Immediately or shortly after the centrifuging process finishes and the rotor 7 comes to a halt, the carriage 10 is activated to illuminate a region of the sample chamber 4, and to capture images of that region of the sample chamber 4. Once an image has been captured, the carriage 10 is driven to a second position, and at this second position the carriage 10 once again illuminates a region of the sample chamber 4, and captures one or more images of this region of the sample chamber 4.

This process is repeated, with the carriage 10 being driven to successively new positions. Preferably, the carriage 10 is driven through a range of positions which includes a first position at or near one end of the sample chamber 4, a final position at or near the other end of the sample chamber 4, and a plurality of intermediate positions, between the first and final positions.

In preferred embodiments, the carriage 10 gathers images of the sample chamber 4 in at least 10 different positions. In further embodiments the carriage 10 gathers images of the sample chamber in at least 20 different positions.

In yet further embodiments the carriage 10 gathers images of the sample chamber 4 in at least 30 different positions. In still further embodiments of the invention, the carriage 10 gathers images of the sample chamber 4 in at least 50 different positions.

In further embodiments, the number of positions is not fixed, but depends upon the length of the liquid that is present in the sample chamber. In these embodiments, the carriage 10 may move along the length of the sample chamber 4, and detect (using the image sensor described below, or any other suitable means) when the region of the sample chamber 4 immediately opposite the carriage 10 contains liquid. Where the region of the sample chamber 4 does contain liquid, the carriage 10 gathers images at predetermined distance intervals, which for example may be as 0.1 mm, 0.5 mm, 1 mm, or 2 mm. However, where the region of the sample chamber 4 does not contain liquid, images are not gathered.

In yet further embodiments, the carriage 10 may gather only a single image. If there is a single feature of interest, that can be captured within the field of view of a single image, then following centrifuging of the sample, the carriage 10 may be driven to a suitable location and capture a single image of the feature. The location of the feature may be determined using the image sensor of the carriage 10, or in any other suitable way. One example of such a feature may be the buffy coat layer of a blood sample.

In embodiments, the carriage 10 may come to a complete stop in order for each image to be taken. In other embodiments, the carriage 10 does not stop as each image is gathered. In these embodiments the carriage 10 may move at a constant or substantially constant rate along its trajectory. Alternatively, the carriage 10 may move at a relatively fast speed when moving between positions, and may travel at a slower speed as each image is taken.

The initial position of the carriage 10 may be aligned or substantially aligned with the inner end 5 of the sample chamber 4, as discussed above, in which case the carriage 10 will be driven towards the outer end 6 as the images are gathered. Alternatively, in its initial position the carriage 10 may be aligned or substantially aligned with the outer end 6 of the sample chamber 4, in which case the carriage 10 will be driven towards the inner end 5 as the images are gathered.

The carriage 10 may have the same initial position for each occasion on which images are gathered. It is also envisaged that, after a set of images has been gathered, the carriage 10 will be positioned either at the inner or outer end 5, 6 of the sample chamber 4, and will remain in this position until the apparatus is used again, at which point this position will be the initial position for the movement of the carriage 10.

It is also envisaged that, when a series of images is gathered, the carriage 10 may begin at a position which is intermediate between the inner and outer ends 5, 6 of the sample chamber 4. The skilled reader will readily understand how this may be implemented.

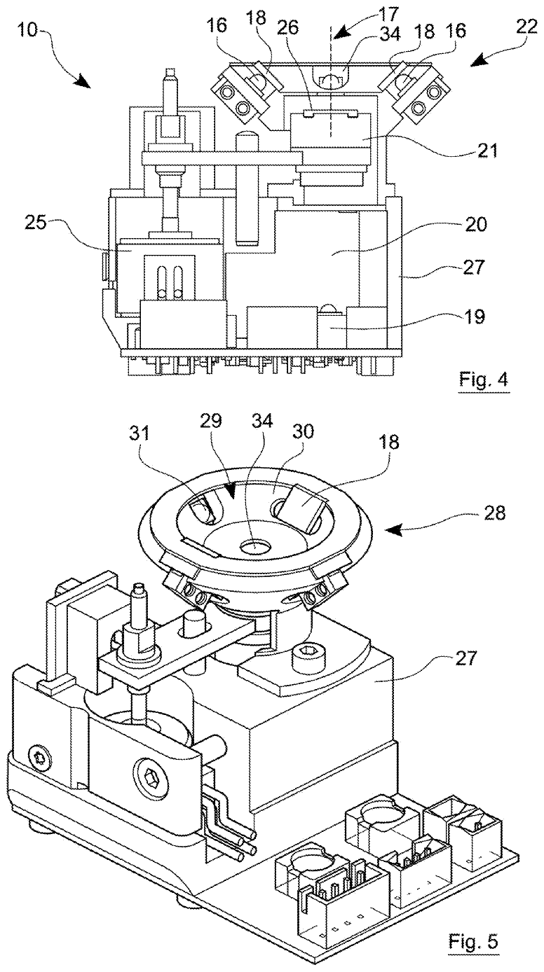

FIG. 4 shows a more detailed view of one embodiment of a carriage 10 suitable for use with the invention.

One end 22 of the carriage 10 includes an illumination arrangement, which is adapted to produce illumination in a region immediately adjacent the one end 22. In use, the one end 22 of the carriage 10 is preferably the end which will lie closest to the sample chamber 4. In the embodiment shown, the illumination arrangement comprises two first LEDs 16.

In the embodiment shown, the carriage 10 has a main axis 17, and this main axis 17 may, when the carriage 10 is installed in a centrifuge and a cuvette is mounted in the rotor 7 of the centrifuge, converge exactly or substantially with a part of the sample chamber 4 of the cuvette 1. In this example each of the two first LEDs 16 is mounted so that it is angled towards this main axis 17.

An LED will generally have a main direction of illumination, in which the strongest illumination is produced. Moving angularly away from this main direction, the intensity of illumination produced by the LED is reduced.

Each of the two first LEDs 16 shown in FIG. 4 are inclined towards the main axis 17, in that each first LED 16 is spaced apart from the main axis 17, but the main direction of illumination of each LED 16 is angled towards the main axis 17.

In the example shown in FIG. 4 the two first LEDs 16 are positioned on opposite or substantially opposite sides of the main axis 17, and arranged so that their main directions of illumination will generally coincide at a point on the main axis 17. The main directions of illumination of the two first LEDs 16 also preferably converge on the sample plane, which in this example is the surface of the sample chamber 4 that faces the carriage 10.

Each of the first LEDs 16 may emit illumination at approximately 470 nm (i.e. the peak of the emission spectrum is at exactly or substantially 470 nm).

In the embodiment shown a first filter 18 is provided in front of each first LED 16. In this example these first filters 18 are short pass filters, which preferentially allow light having short wavelengths to pass (such filters are also known as “high pass” filters, as they allow high frequencies of light to pass).

In the embodiment shown each first filter 18 is a 500 nm short pass filter, which generally allows wavelengths of light below 500 nm to pass, but blocks wavelengths above 500 nm.

In discussions of filters in this document, the skilled reader will understand that the transmission profile of a filter is not a sharp cut-off at an exact frequency.

The first LEDs 16 provide illumination of a region of the sample chamber 4 immediately adjacent the carriage 10. The skilled reader will appreciate that only one first LED may be provided, or that three or more first LEDs may be provided for this purpose.

The skilled reader will also appreciate that any suitable illumination source may be used, and that it is not essential to use LEDs.

The carriage also includes an image sensor 19, which in the embodiment shown comprises a CMOS sensor. However, any suitable image sensor, such as a CCD, may also be used. It is also envisaged that the sensor may be of a type which captures data within multiple wavelength ranges across the electromagnetic spectrum, i.e. multispectral sensor. The image sensor may comprise a one-dimensional array of pixels, or a two-dimensional array of pixels.

In preferred embodiments the carriage 10 has an imaging aperture 34, through which light may pass to impinge on the image sensor 19. In the example shown in FIG. 4, the imaging aperture 34 is positioned between the first LEDs 16. The imaging aperture 34 may be arranged so that light impinging on the carriage 10 exactly or substantially along the main axis 17 passes through the imaging aperture 34.

In the embodiment shown in FIG. 4 the carriage 10 has a generally elongate body 20, with the illumination arrangement comprising the first LEDs 16 provided at a first end 22 thereof, which is shown as the top end in the orientation shown in FIG. 4. A lens 21 is positioned beneath the illumination arrangement, and positioned so that light impinging on the upper end 22 of the carriage 10 and passing through the imaging aperture 34 may be focused by the lens 21 onto the image sensor 19.

An autofocus lens gear and autofocus pinion gear are provided to position the lens 21 so that light is focused correctly. An autofocus motor and gearbox 25 are also provided to drive the autofocus lens gear and autofocus pinion gear, as will be understood by the skilled reader.

A second filter 26 is provided so that light impinging on the image sensor 19 passes through the second filter 26. In the embodiment shown in FIG. 4 the second filter 26 is positioned between the imaging aperture 34 and the lens 21.

In this embodiment the second filter 26 is a low pass filter. In this example the second filter 26 is a 525 nm long pass filter, i.e. a filter which preferentially allows wavelengths of light which are above 525 nm to pass, and blocks wavelengths of light below 525 nm.

The effects of the first and second filters 18, 26 will be discussed in more detail below.

The skilled reader will appreciate that, in use, as the carriage 10 reaches each position at which an image is to be captured, the first LEDs 16 illuminate a region of the sample chamber 4 which is near the carriage 10, and an image of the illuminated region is captured by the image sensor 19. The carriage 10 will therefore capture a sequence of images along the length of the sample chamber 4.

In preferred embodiments, there is overlap between successive images, i.e. for each image there is at least one part of the sample chamber 4, the liquid sample itself, and/or the rotor 7 which appears in the image, and which also appears in the next image which is captured. It is also envisaged that, in further embodiments, some or all of the images are taken without overlap with successive images. For instance, images may only be gathered where there are features of interest. Between features of interest there may be regions of the sample chamber that are not included in the images captured.

In preferred embodiments, once the sample has been centrifuged, a sequence of images is taken in an imaging time which is less than one minute.

In further embodiments, the imaging time is less than 30 seconds.

In general, having a short imaging time is preferred, so that the phases of the liquid have as little time as possible to move from the stratified arrangement which immediately follows the centrifuging process.

FIG. 5 shows another view of the carriage 10. In this view, many of the internal components are hidden by a housing 27.

In the embodiment shown the first LEDs 16, first filters 18 and imaging aperture 34 are provided on a protrusion 28 which extends from a top surface of the housing 27. An indentation 29 is formed on a top side of the protrusion 28. In preferred embodiments the indentation 29 is generally circular. In the example shown in FIG. 5 the indentation 29 has a slanting side wall 30, which extends all the way around the indentation 29.

The first LEDs 16, shown in FIG. 4, are positioned on opposing sides of the side wall 30. As discussed above, the first LEDs 16 are arranged to be inclined towards the main axis 17 of the carriage 10. In this embodiment, this is achieved at least partly by positioning the first LEDs 16 on the slanting side wall 30 of the indentation 29.

Positioning the first LEDs 16 on the slanting side wall 30 also allows the first LEDs 16 to be close to the sample in the sample chamber 4, thus allowing the sample to be illuminated as effectively as possible by the first LEDs 16. In general, in preferred embodiments of the invention the first LEDs 16 are positioned closer to the sample chamber than the image sensor 19 is to the sample chamber 4.

In the example shown in FIG. 5, the first LEDs 16 are not visible, as they are obscured by the respective first filters 18.

Also shown in FIG. 5 is a second LED 31, which is again positioned on the side wall 30 of the indentation 29. While only one second LED 31 can be seen, in the embodiment of FIG. 5 there is a further second LED 31, which is positioned on the opposite side of the indentation 29 from the second LED 31 which is visible in FIG. 5.

In preferred embodiments of the invention, the carriage 10 is arranged with respect to the cuvette 1 so that the first LEDs 16 are substantially aligned with the sample chamber 4. In other words, a line connecting the first LEDs 16 would be parallel or substantially parallel with the length of the sample chamber 4. This ensures that the illumination produced by the first LEDs 16 illuminates the layers of the liquid in the sample chamber 4 as effectively as possible.

This is preferably the case regardless of whether the second LEDs 31 are also provided.

In the arrangement shown in FIG. 5, the second LEDs 31 are arranged to be generally at right angles to the sample chamber 4. In other words, a line connecting the second LEDs 31 would be generally perpendicular to the length of the sample chamber 4.

Once again, in the arrangement shown in FIG. 5, the second LEDs 31 are angled inwardly, in a similar manner to the first LEDs 16.

When the cuvette 1 is installed in the rotor 7, the main axis 17 of the carriage 10 preferably passes through, or close to, a central region of the sample chamber 4, i.e. a region of the sample chamber 4 which is midway or approximately midway between the two side edges of the sample chamber 4. The second LEDs 31 may be angled towards the main axis 17 so that the illumination produced by the second LEDs 31 converges at a point on the main axis 17 which coincides exactly or substantially with the sample plane, which is preferably the surface of the sample chamber 4 which faces the carriage 10.

The positioning of the second LEDs 31 substantially at right angles to the sample chamber 4 ensures that the second LEDs 31 illuminate the edges of the sample chamber 4 in an effective manner. This is important so that, in each of the images captured by the image sensor 19, the edges of the sample chamber 4 appear clearly and distinctly. This provides two advantages. Firstly, if the edges of the sample chamber 4 appear clearly in each image, then when the images are combined the images can be scaled and aligned reliably, because the edges in each image can be aligned with each other.

Secondly, if the edges appear clearly in each image, the width of the sample chamber 4 in the image can be clearly determined, thus allowing accurate calibration of the absolute sizes of other features which appear in the images (since the real width of the sample chamber 4 will be known).

The imaging aperture 34 is, in this example, positioned in the centre of the indentation 29. Light may pass through the imaging aperture 34 to impinge on the image sensor 19. The imaging aperture 34 may be exactly or substantially aligned with the central axis 17, as shown in FIG. 4.

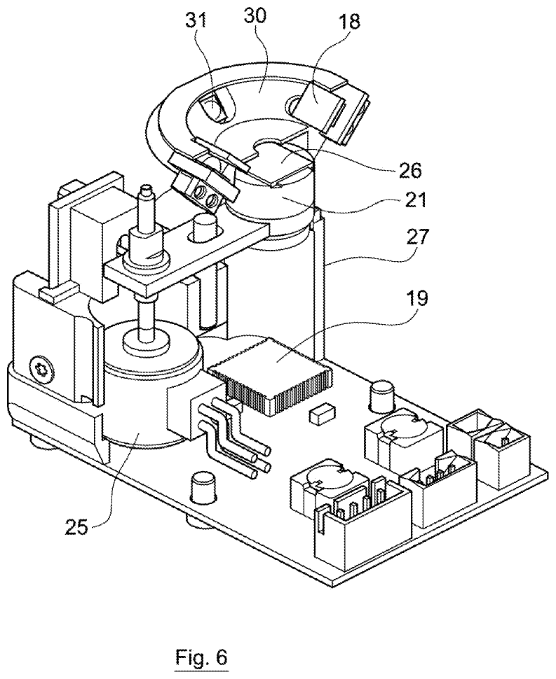

FIG. 6 shows a cutaway view corresponding to the view shown in FIG. 5.

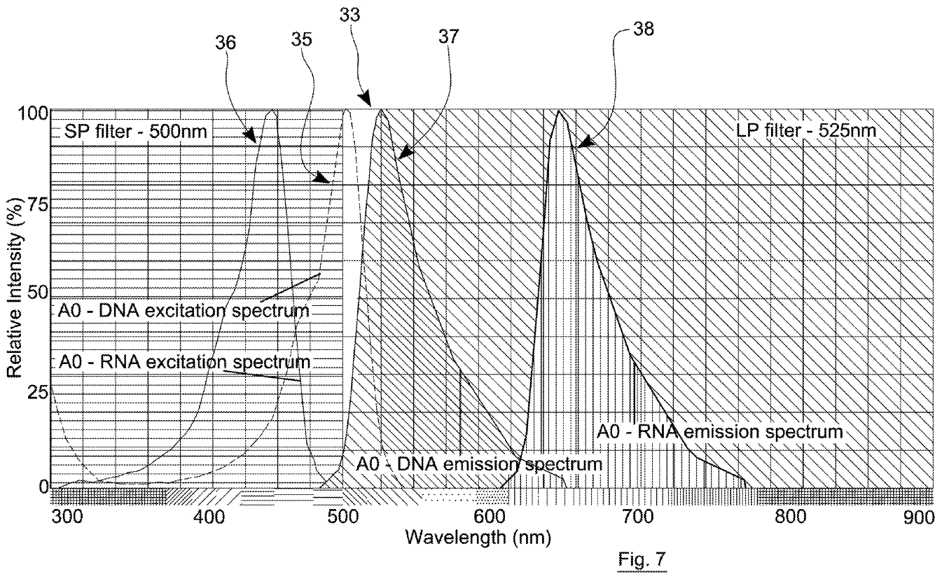

FIG. 7 shows a graph of wavelength against relative intensity, and helps to illustrate benefits of using the first and second filters 18, 26.

As mentioned above, each first filter 18 is a 500 nm short pass filter, and is provided in front of a respective first LED 16. In embodiments of the invention the blood sample in the sample chamber 4 may be mixed with acridine orange (AO), a dye which attaches to RNA and DNA and which fluoresces when illuminated with suitable radiation. The fluorescence of AO can therefore provide an accurate measure of RNA or DNA content.

In human blood, DNA is present in white cells, whereas red blood cells contain RNA but substantially no DNA. Location of RNA and DNA in a blood sample is therefore of assistance in identifying the different phases of the blood.

FIG. 7 shows the AO DNA and RNA excitation spectra. As can be seen, the AO RNA excitation spectrum 36 falls almost entirely below 500 nm. Around half of the AO DNA excitation spectrum 35 also falls below 500 nm.

FIG. 7 also shows the AO DNA and RNA emission spectra 37, 38. Substantially all of the RNA emission spectrum 38 falls above 525 nm, and around half of the DNA emission spectrum 37 also falls above 525 nm.

The first LEDs 16 serve to illuminate the liquid in the sample chamber 4. Light from the first LEDs 16 passes through the first filters 18, and the resulting light which impinges upon the sample chamber 4 will be of suitable wavelengths to excite the AO associated with the RNA and DNA in the sample.

Providing the second filter 26, which is a low pass filter allowing only wavelengths above 525 nm to pass, ensures that the light which reaches the image sensor 19 coincides with the majority of the RNA and DNA emission spectra for AO, thus ensuring that light which is emitted by the sample, as a result of the excitation caused by the first LEDs 16, reaches the image sensor 19 successfully.

This arrangement of filters 18, 26 also ensures that any light from the first LEDs 16 which is reflected or refracted directly towards the image sensor 19, will be blocked by the second filter 26 and will therefore not affect the amount of useful data within the images.

The skilled reader will also note that there is a gap 33, which in the example shown has a width of 25 nm, between the threshold of the 500 nm short pass filter and the threshold of the 525 nm long pass filter. As discussed above, in practice the transmission profiles of filters do not comprise sharp edges at an exact wavelength, and providing this gap 33 helps to ensure that light from the first LEDs 16 does not appear in images gathered by the image sensor 19.

In preferred embodiments, light from the second LEDs 31 is at a wavelength which will pass through the second filter 26, and hence can pass through the second filter 26 and impinge on the image sensor 19 so that the edges of the sample chamber 4 appear clearly in images gathered by the image sensor 19.

In an embodiment, the second LEDs 31 emit green light, having a wavelength of around 550 nm. This light is preferably reflected directly from the edges of the sample chamber, and then impinges upon the image sensor 19.

Importantly, the light emitted by the second LEDs is outside or substantially outside the AO DNA and RNA excitation spectra. This means that the light from the second LEDs 31 will not lead to unwanted excitation of the AO in the sample.

The use of AO as a dye or marker is not essential, and the skilled reader will be aware of other suitable dyes which can be used to assist in imaging of samples.

In general, where a sample, or phase of a sample, will be excited by illumination by light having a first, lower range of wavelengths, and will subsequently emit radiation having a second, higher range of wavelengths, an apparatus embodying the invention may have an illumination source, wherein illumination from the illumination source passes through a first filter before impinging on the sample, and wherein the first filter blocks light having wavelengths above a first threshold, wherein all or most of the second range of wavelengths are above the first threshold. The apparatus may also have a second filter, arranged so that light impinging on the image sensor passes through the second filter. The second filter blocks light having wavelengths below a second threshold, wherein all or most of the first range of wavelengths are below the second threshold. In these embodiments the second threshold is higher than the first threshold.

It is also envisaged that the one or more filters may be positioned to filter light reaching the image sensor, such that only wavelengths within a certain band can pass through the filters. For instance, wavelengths between 525 and 600 nm may be allowed to pass, with longer and shorter wavelengths being blocked.

Once a series of images has been taken, the images can be combined to form a single composite image, which preferably covers the entire length of the sample chamber 4 that is occupied by the liquid sample. The composite image can be created by matching portions of edges of successive images, by matching features which appear in both images. This technique is well-understood, and will not be discussed in detail in this document.

The creation of this single image allows accurate analysis of the phases of a sample which is contained in the sample chamber 4.

For instance, if the length of the sample chamber which is occupied by red blood cells can be accurately measured, and the entire length of the sample (including all phases) can also be accurately measured, then the ratio of the volume of red blood cells to the total volume of the sample can be determined. Measurement of phases in this way can, for example, allow accurate determination of the haematocrit, and/or mean corpuscular haemoglobin concentration (MCHC), of a blood sample.

The layers which appear in the buffy coat region of the sample may also be analysed in detail.

As an alternative to this, as discussed above, the carriage 10 may gather images only in locations of interest. There may be regions of the sample chamber 4 which are not included in the images that are gathered by the carriage 10.

In these embodiments, the position of the carriage 10 as each image is taken may be recorded, to allow an accurate determination of the location of that image. As one example of this, the step count of a motor that drives the carriage 10 may be used to determine the position of the carriage 10 as an image is taken.

In some embodiments, the carriage 10 may capture images only in positions, or ranges of positions, where a feature of interest is likely to be found. For instance, if it is desired to capture images of the buffy coat region of a blood sample, the carriage may only capture images in a region where the buffy coat is likely to lie. As an example, it may be expected that 30%-60% of the total volume of the blood sample will comprise red blood cells. The buffy coat layer will lie substantially immediately beside the end of the portion of the sample that comprises red blood cells. The carriage 10 may therefore be controlled to gather images within a region which covers the range of positions which is likely to contain the end of the portion of the sample that comprises red blood cells. This region extends to cover this range of positions, and may also include a margin on either side of the range of positions. The margin may be, for example, 5% of the volume of the sample, and so in this example the carriage 10 would capture images within a range extending from 25%-65% of the volume of the sample (extending from the second end 6 of the sample chamber 4). There may be regions on either side of this range where images are not captured.

If a stepper motor is used, then the range of positions in which images to be captured may be controlled by designating a range of steps of the motor in which images are to be captured. For instance, the carriage 10 may be controlled to capture images between step counts of 1,000 and 1,500.

As an alternative to this, images captured by the carriage 10 may be analysed to determine whether a feature of interest is present. Staying with the example of the buffy coat, the buffy coat has a distinctive colour, which is different from the colours of the red blood cells and serum, which are on either side of the buffy coat. Within a pre-set range, or over the entire length of the sample, the carriage 10 may advance along the length sample chamber, capturing images at intervals. After each image is taken the image may be analysed (for instance, by analysing the presence or intensity of one or more colours in the image, which could be achieved by determining the profile of each colour channel) to reach a determination as to whether the buffy coat, or any part of the buffy coat, appears in the image. If it is determined that the buffy coat does not appear in the image, then the image is discarded without being stored. However, if any part of the buffy coat appears in the image, the image is stored (along with data representing the location of the carriage 10).

After the carriage 10 has been driven along the length of the sample chamber 4, the relative locations of the images gathered can be determined, and so the distances between the features which appear in the images can be calculated accurately. Optionally, a composite image may be created, based on the images that have been gathered, with this composite image having gaps corresponding to regions of the sample chamber where no images were gathered.

In some embodiments, only a single image may be taken, covering a feature of interest.

Taking a number of relatively close-up images of parts of the sample, rather than taking a single “wide angle” image of the sample, means that the resolution achieved can be significantly greater than with conventional methods, in which a single wide angle image of the entire sample is taken. The resolution achieved using embodiments of the invention may also allow different types of blood cell to be discerned. Resolutions of around 5 μm may be achieved, and the majority of white blood cells have sizes in the range of 10-15 μm.

Textural analysis may also be used to distinguish between different layers or components of the sample. For instance, if a first layer or region has cells with a size of around 2 μm, and a second layer or region has cells with a size of around 15 μm, then it may be possible to distinguish between the layers or regions algorithmically, due to pattern differences in the respective regions of images.

In embodiments of the invention, each image gathered by the carriage 10 corresponds to a field of view which is around 3 mm in width and around 2.4 mm in length. Preferably, each image corresponds to a field of view which is less than or equal to 5 mm by 5 mm, and more preferably each image corresponds to a field of view which is less than or equal to 3 mm by 3 mm.

In the arrangements discussed above, the illumination arrangement and the image sensor are provided in a single carriage. However, it is envisaged that in other embodiments, the illumination arrangement may be positioned on one side of the sample chamber, and the image sensor may be provided on the other side of the sample chamber. In such an embodiment, a moving carriage may be provided which includes the image sensor, but not the illumination arrangement. The carriage may be driven to move along all or part of the length of the sample chamber, capturing images, as discussed above. As this occurs the illumination arrangement will illuminate the sample, from the other side of the sample chamber (e.g. the carriage may be positioned below the rotor, and the illumination arrangement may positioned above the rotor, or vice versa).

The illumination arrangement may illuminate all or substantially all of the sample within the sample chamber as each of the images are being captured. In such embodiments the illumination arrangement may comprise a sequence of light sources, such as LEDs, which are aligned or substantially aligned with the length of the sample chamber, and which are all illuminated as the images are being captured.

Alternatively, only the region which an image is being captured may be illuminated by the illumination arrangement. In such embodiments, the illumination arrangement may again comprise a sequence of light sources which are aligned or substantially aligned with the length of the sample chamber, but as an image of a region of the sample is captured, only a subset of the light sources, which illuminate that region, are activated. As a further alternative, the illumination arrangement may be provided as part of a second carriage, which is driven to travel along all or part of the length of the sample chamber. The second carriage may be driven to move in the same way as the carriage that contains the image sensor.

The skilled reader will appreciate that embodiments of the invention provide a powerful and improved apparatus and method for analysis of blood sample, which will find application in many fields.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

1. An apparatus for analyzing a sample, the apparatus comprising:
a centrifuge rotor having an analysis site suitable for receiving a sample holder having an elongate sample chamber, the analysis site extending between an inner end, which is at a first distance from a center of rotation of the rotor, and an outer end, which is at a second distance from the center of rotation of the rotor, the inner end being closer to a center of rotation of the rotor than the outer end;
a carriage having an illumination arrangement and an image sensor; and
a drive arrangement operable to drive the carriage along a trajectory with respect to the rotor, the trajectory extending between a first location which is relatively close to the center of rotation of the rotor, and a second location which is relatively far from the center of rotation of the rotor, the trajectory extending over at least part of a radial distance between the inner and outer ends of the analysis site;
wherein the carriage is operable, at a plurality of locations along the trajectory, to illuminate a part of the analysis site with the illumination arrangement, and to capture an image of at least a portion of the illuminated part of the analysis site with the image sensor.

2. The apparatus according to claim 1, wherein the illumination arrangement comprises one or more first light sources.

3. The apparatus according to claim 2, wherein the one or more first light sources are positioned closer to the rotor than the image sensor is to the rotor.

4. The arrangement according to claim 2, wherein the illumination arrangement comprises two or more first light sources, each of the first light sources being inclined towards a main axis of the illumination arrangement.

5. The arrangement according to claim 4, wherein light emitted by at least two of the first light sources converges at a location which lies on or substantially on the analysis site.

6. The arrangement according to claim 1 wherein the drive arrangement is operable to cause the carriage to stop its motion at each location as an image is taken.

7. (canceled)

8. The arrangement according to claim 1, wherein the illumination arrangement emits illumination only below or substantially only below a first wavelength threshold.

9. The arrangement according to claim 8, wherein the illumination arrangement further comprises a first filter which is arranged such that light emitted from at least one first light source passes through the first filter before illuminating the analysis site.

10. The arrangement according to claim 9, wherein the first filter only allows or substantially only allows light having a wavelength below the first wavelength threshold to pass therethrough.

11. The arrangement according to claim 10, further comprising a second filter, arranged so that light impinging on the image sensor passes through the second filter.

12. The arrangement according to claim 11, wherein the second filter only allows or substantially only allows light having a wavelength above a second wavelength threshold to pass therethrough.

13. The arrangement according to claim 12, wherein;
the illumination arrangement emits illumination only below or substantially only below a first wavelength threshold;
the arrangement further comprises a second filter, arranged so that light impinging on the image sensor passes through the second filter;
the second filter only allows or substantially only allows light having a wavelength above a second wavelength threshold to pass therethrough; and
the second threshold is higher than the first threshold.

14. The arrangement according to claim 1, wherein the illumination arrangement further comprises one or more second light sources.

15. The arrangement according to claim 1, wherein;
the illumination arrangement comprises one or more first light sources;
the illumination arrangement further comprises one or more second light sources, and
the second light sources emit illumination at a different frequency or range of frequencies to that of the one or more first light sources.

16. The arrangement according to claim 12, wherein the illumination arrangement further comprises one or more second light sources, and wherein light emitted by the one or more second light sources has a wavelength which is above the second threshold.

17. (canceled)

18. The arrangement according to claim 1, further comprising a cuvette which is adapted to be received and retained at the analysis site, wherein the cuvette has an elongate analysis chamber which, when the cuvette is received and retained at the analysis site, lies parallel or substantially parallel with a radius of the rotor.

19. The arrangement according to claim 18 wherein, when the cuvette is received and retained at the analysis site, in at least one rotational orientation of the rotor the trajectory of the carriage extends over a majority of a length of the sample chamber.

20. (canceled)

21. A method of analyzing a liquid sample, the method comprising the steps of:
collecting the sample in an elongate sample chamber of a cuvette;
providing an apparatus according to claim 1;
placing the cuvette in the analysis site of the rotor;
rotating the rotor to centrifuge the sample;
following centrifuging of the sample, driving the carriage along the trajectory, and at a one or more locations along the trajectory, illuminating a region of the sample chamber with the illumination arrangement, and capturing an image of at least part of the illuminated region of the sample chamber with the image sensor.

22. The method according to claim 21, including capturing images at a plurality of locations along the trajectory.

23. The method according to claim 22, including capturing images of at least 10 regions of the sample chamber.

24. (canceled)
